(19) United States
(12) Patent Application Publication
(10) Pub. No.: US 2026/0087865 A1
(43) Pub. Date: Mar. 26, 2026

(54) METHODS FOR ENHANCED LEVEL IN SECURITY IN ACCESS CONTROL PERFORMED BY AN AUTHENTICATION SERVER, AN ACCESS CONTROL DEVICE AND A KEY RESPECTIVELY, USING CHALLENGE AND RESPONSE AND OPTIONALLY INVOLVING MULTIPLE DEVICES

(71) Applicant: Telefonaktiebolaget LM Ericsson (publ), Stockholm (SE)

(72) Inventors: Tommy ARNGREN, Södra Sunderbyn (SE); Patrik SALMELA, Espoo (FI); Peter ÖKVIST, Luleå (SE); Niklas LINDSKOG, Lund (SE); Henrik NORMANN, Malmö (SE); Daniel BERGSTRÖM, Luleå (SE)

(21) Appl. No.: 19/108,790

(22) PCT Filed: Sep. 6, 2022
(86) PCT No.: PCT/SE2022/050792

§ 371 Date: Mar. 5, 2025

(51) Int. Cl. G07C 9/00; H04L 9/08; H04L 9/32

(52) U.S. Cl. CPC G07C 9/00571; H04L 9/085; H04L 9/3271; G07C 2209/04

(57) ABSTRACT

A method (800) for access control. The method includes receiving (s802), at an authorization server (106), an indication that the user (101) has used or intends to use a key (102) in an attempt to gain access to a property (112), wherein access to the property is controlled by an access controller (104). The method also includes, after receiving the indication, the authorization server transmitting (s804) a first challenge to a first device associated with the user. The method also includes the authorization server receiving (s806) from the first device a response to the first challenge. The method also includes using the response to the first challenge, the authorization server determining (s808) whether the user is authorized to access to the property. The method further includes the authorization server sending (s810) a message indicating whether or not the user is authorized to access the property.

### TECHNICAL FIELD

Disclosed are embodiments related to authentication.

### BACKGROUND

Typically, with today's security technology, a user unlocks a vehicle by employing a key (a.k.a., “key fob” or “fob” for short) that broadcasts a radio signal so that the signal can be received by an access controller in the vehicle, and the access controller, based on the data carried in the signal, determines whether or not to unlock a door. Although the user employs a key to remotely unlock the car door, this is often referred to as “keyless entry” because a physical key is not inserted into a lock to unlock the door. Both relay and replay attacks are well known related to keyless entry. Other examples of keyless entry may be found in home entry/lock solution (see, e.g., www(dot)yalehome(dot)com/se/sv and Hassani, R., “Security evaluation of a smart lock system,” Kth Royal Institute of Technology, Stockholm Sweden 2021 (available at kth(dot)diva-portal(dot)org/smash/get/diva2:1533957/FULLTEXT01.pdf)).

Today's smartphone, smartwatch, and tablet solutions use two-step verification where a certain activity at a first device renders a request for response-action at a second (trusted and previously paired) device. This is legacy for Apple devices logged in at same iCloud account. Similarly, when accessing an online service (e.g., an online banking service), a user may face an authentication challenge operating at one screen (tablet) and at that screen via social security number and/or or time-dynamic QR code rendered for some second device to read with the online service application using the device's camera to pair the authentication session and then using authentication (such as biometrics/face/finger ID or PIN code) at second device.

### SUMMARY

Certain challenges presently exist. For instance, keyless entry devices used to access expensive and valuable properties such as a car, a home, etc., are potential targets for different security risks such as relay attacks or replay attacks.

Accordingly, in one aspect there is provided a method for access control performed by an authorization server. The method includes the authorization server receiving an indication that the user has used or intends to use a key in an attempt to gain access to a property, wherein access to the property is controlled by an access controller. The method also includes, after receiving the indication, the authorization server transmitting a first challenge to a first device associated with the user. The method also includes the authorization server receiving from the first device a response to the first challenge. The method also includes the authorization server using the response to the first challenge to determine whether the user is authorized to access to the property. The method also includes the authorization server sending a message indicating whether or not the user is authorized to access the property.

In another aspect there is provided a method for access control performed by a key. The method includes the key transmitting to an authorization server a first message comprising information indicating that a user has used or intends to use the key in an attempt to gain access to a property, wherein access to the property is controlled by an access controller.

The method also includes the key transmitting to the access controller a second message comprising first authorization data (e.g., information that enables the access controller to determine that key is authorized).

In another aspect there is provided a method for access control performed by an access controller configured to control access to a property. The method includes the access controller receiving from a key operated by a user a first message comprising first authorization data. The method also includes, after receiving the first message, the access controller determining whether an enhanced level of security is required before a user of the key can gain access to the property. The method also includes, as a result of determining that the enhanced level of security is required, the access controller transmitting a second message comprising information indicating that the access controller has determined that an enhanced level of security is required, wherein the access controller sends the second message to either i) an authorization server) or ii) the key. The method also includes, after transmitting the second message, receiving second authorization data generated by the authorization server indicating whether or not the user is authorized to access the property.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of the embodiments disclosed herein is that they provide an additional level of security when needed.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a flowchart illustrating a process according to an embodiment.

FIG. 3 is a message flow diagram according to an embodiment.

FIG. 4 is a message flow diagram according to an embodiment.

FIG. 5 is a message flow diagram according to an embodiment.

FIG. 6 is a message flow diagram according to an embodiment.

FIG. 7 is a message flow diagram according to an embodiment.

FIG. 8 is a flowchart illustrating a process according to an embodiment.

FIG. 9 is a flowchart illustrating a process according to an embodiment.

FIG. 10 is a flowchart illustrating a process according to an embodiment.

FIG. 11 is a block diagram of a server according to an embodiment.

FIG. 12 is a block diagram of a device according to an embodiment.

### DETAILED DESCRIPTION

### Introduction

This disclosure describes embodiments for providing increased security related to, for example, keyless entry (e.g., keyless access to properties with high value such as a car, a house etc.). In one embodiment, there is provided a server that manages a user's devices and that, depending on certain conditions, triggers a 3^{rd} device to approve access to a property.

### Additional Details and Use Cases

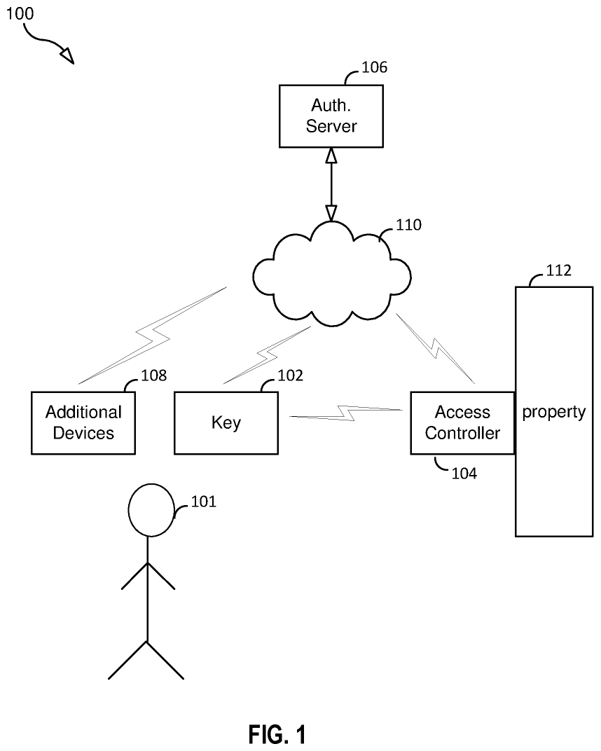

FIG. 1 illustrates a system 100 according to an embodiment. System 100 includes a key 102 for use in allowing a user 101 to access a property 112 that is protected by an access controller 104. The property 112 can be a house, a car, a safe, a room, an appliance, a sensor, a computing device, a communication device, a service, a digital object, information, etc. Access controller 104 may be co-located with property 112 or remote from property 112. Key 102 has the ability to wirelessly provide authentication data to access controller 104 (e.g., key 102 has ability to transmit a radio signal carrying the authentication data). Key 102 can take any form. For example, key 102 could be a smartphone running a key app, a hardware module within a device or a device with the sole purpose of allowing the user to access a property, such as a key fob.

System 100 also includes an authorization server 106. In this example, both key 102 and access controller 104 have the capability to communicate with authorization server 106 via a network 110. Network 110 may comprise multiple networks, such as a radio access network (RAN) operated by a mobile network operator (MNO), a core network (CN) operated by the same MNO or another MNO, a packet data network (PDN) (e.g., the internet), and/or a local area network (e.g., a Bluetooth network or near field communication (NFC) network).

While authorization server 106 is shown as being separate and apart from access controller 104, server 106 may be a component of access controller 104 or access controller 104 may be a component of server 106.

In one embodiment, access controller 104 does not provide the user with access to the property unless and until access controller 104 receives from authorization server 106 an authorization message indicating that the user is authorized to access the property. In some embodiments, authorization server 106 has access to information about additional devices 108 associated with user 101 (e.g., devices registered to the user and/or worn or carried by the user). The additional devices 108 can consist of a single additional device or multiple additional devices. The additional devices can be, for example, any device, such as, but not limited to: smart watch, smart fabrics, eyewear (e.g., glasses, contact lens, etc.), jewelry, biomedical devices, smartphone, tablet, laptop, computer, sensor, clothing, vehicle, etc.

In some embodiments, authorization server 106 is operable to determine whether enhanced authentication is required before allowing access controller 104 to grant the user with access to the property (i.e., before sending the authorization message to access controller 104).

In one embodiment, authorization server 106 detects an access event triggered by key 102 and assesses related context information to determine whether further authentication is needed. The context data can be transmitted to server 106 by any one of the additional devices 108, key 102, and/or access controller 104. In some embodiments, authorization server 106 detects the access event by receiving a message transmitted by key 102 or a message transmitted by access controller 104, where the message indicates that a user is attempting to access the property.

In some embodiments, if server 106 determines that further authorization is needed, server 106 selects (randomly or based one or more factors, such as, for example, value of the property, assessed task complexity, risk level, convenience, previous authentication use patterns, previously used devices, policy, etc.) one or more of the additional devices 108 and transmits a challenge to the selected additional device(s). In some embodiments, the challenge that server 106 sends to a selected additional device 108 is generated (e.g., chosen) based on and adapted to the selected additional device's capabilities.

Each of the additional device(s) receiving the challenge transmits a challenge response to server 106. Based on the challenge response(s) received from the selected additional device(s), server 106 determines whether or not to inform access controller 104 that it may grant access to the user (i.e., server 106 determines whether the user attempting to gain access to the property has been sufficiently authenticated). For instance, in some embodiments, based on based on the challenge response(s) received from the selected additional device(s), server 106 chooses not to send the authorization message to access controller 104, but rather selects a new set of additional devices and transmits a challenge to each device in the new set of devices. Based on the challenge responses from these additional device(s), server once again determines whether or Not to Inform Access Controller 104 That it May Grant Access to the User. This Process can be repeated as needed.

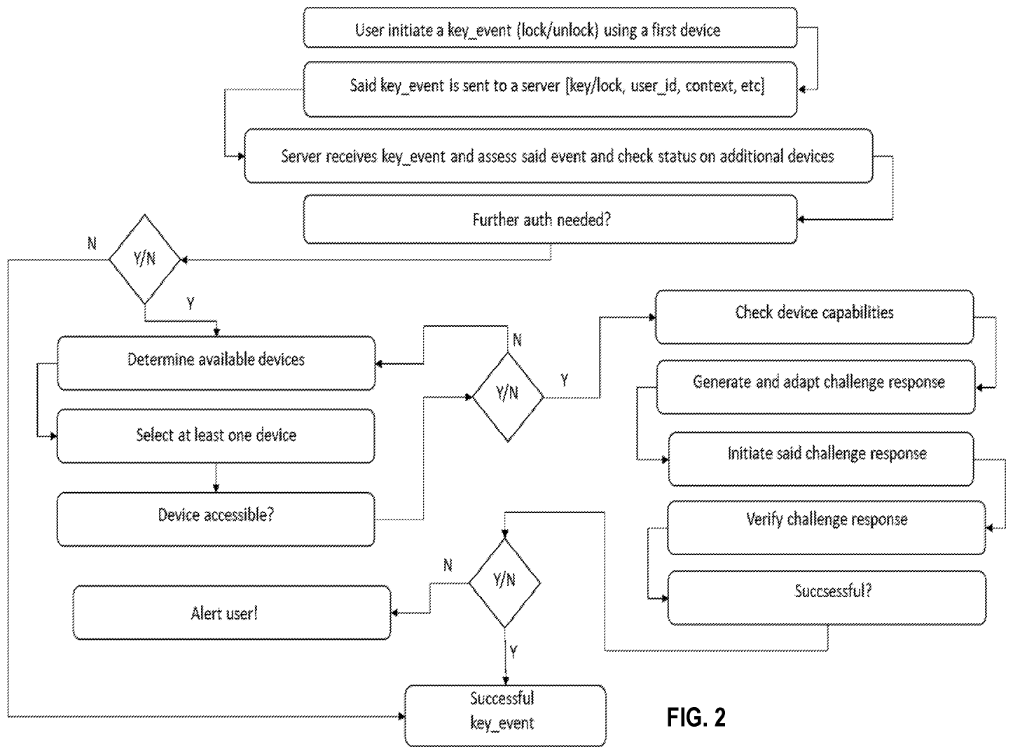

FIG. 2 is a flow chart illustrating a process according to an embodiment. The process begins with user 101 (or “the user”) initiating a key event. For example, the process begins with the user causing key 102 to transmit (e.g., via WiFi, Bluetooth, NFC, RFID, etc.) to access controller 104 an authorization request message comprising authorization data (e.g., action identifier (e.g., “unlock”) and/or other data).

Next, an authorization request message is sent to authorization server 106, where the authorization request message indicates the key event, for example, indicating that a user has used key 102 in an attempt to perform an “unlock” operation. The authorization request message may further include a user id associated with key 102 and context information.

Server 106 receives the authorization request message and then, based on a policy and/or authorization data included in the authorization request message, determines whether to inform controller 104 that the user is authorized to perform the key event (e.g., unlock the car door) or to obtain additional information before making the decision as to whether or not to allow the user to gain access to the property.

Next (assuming further information is needed), server 106 determines whether there are any additional devices that it can direct a challenge to. If there are such additional devices, server 106 selects at least one of the devices and determines whether the selected device is currently accessible.

Assuming the selected device is accessible, server 106 retrieves capability information for the device and generates a challenge adapted to the device's capabilities. The generated challenge is then sent to the selected device (directly or via another device, such as, but not limited to the access controller or the key), which, if operating correctly, transmits to server 106 (directly or indirectly) a challenge response.

Server 106 then verifies the challenge response (e.g., server 106 determines whether the challenge response includes a certain token, such as, for example, a token generated by server 106). Assuming the challenge response is verified, server 106 may send a successful authorization message to controller 104, thereby informing controller 104 that server authorizes the user of key 102 to gain access to the property.

### Authorization Request Message

The authorization request message may be transmitted by key 102, access controller 104, or one of the additional devices 108. Accordingly, at least one of these devices has capabilities to communicate with server 106. Also, devices may have different trust levels, e.g. devices with both device-to-device (D2D) communication capability (e.g., WiFi, Bluetooth, short range radio frequency (RF) transmission, etc.) and cellular access have higher trust and that devices that only have D2D capability, but no cellular network capability.

### Authorization Request Message From Key

In this embodiment, key 102 has capabilities for both D2D and cellular network connectivity.

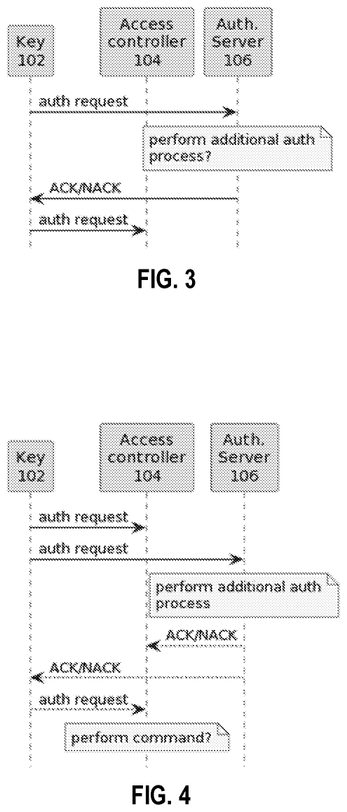

FIG. 3 is a message flow diagram illustrating a message flow according to an embodiment where key 102 sends an authorization request including authorization data such as: user_id, device_id, key_id, authorization token, signal strength, action id indicating a requested action (e.g., “unlock” or “start car”), etc., to server 106 (e.g., using cellular network) prior to sending an authorization request to controller 104.

In this example the additional authorization support from the server 106 is proactively requested by key 102. Key 102 may be configured to send the authorization request to server 106 whenever key 102 is requested by a user to send an authorization request to controller 104. Key may also be configured such that, when key 102 is requested to transmit an authorization request to controller 104, key decides based on a randomly generated value or a rule that key 102 should first send an authorization request to server 106 before sending the authorization request to controller 104. The rule may cause key 102 to decide whether to first send authorization request to server before sending authorization request to controller 104 based on context information (e.g., location data, time of day, day of week, history data, etc.).

After receiving the authorization request transmitted by key 102, server 106 determines whether or not to perform an enhanced authorization process. In any event, server 106 will send to key a response responsive to the authorization request, which response will either indicate an ACK (key is authorized to proceed) or indicate a nack (key is not authorized to proceed).

Assuming key receives a response indicating an ACK, key sends to controller an authorization message including authorization data described above and/or data included in the response message from server 106. In this use case, key 102 does not send an authorization request to controller until it get the “OK” from server 106.

After receiving the authorization request from key, controller will then decide whether to perform the action indicated by the authorization request, not perform the action, or escalate to the server (as described below with respect to FIG. 6).

FIG. 4 is a message flow diagram illustrating a message flow according to an embodiment where key 102 simultaneously (i.e., at or near same time) i) sends to controller 104 (e.g., using short range radio) a first authorization request including authorization data and ii) sends to server 106 a second authorization request including authorization data. In this example the additional authorization support from the server 106 is proactively requested by key 102. Key 102 may be configured to send the authorization request to server 106 whenever key 102 is requested by a user to send an authorization request to controller 104. Key may also be configured such, when key 102 is requested to transmit an authorization request to controller 104, key decides based on a randomly generated value or a rule that key 102 should also send an authorization request to server 106. The rule may cause key 102 to decide whether to send the authorization request to server based on context information (e.g., location data, time of day, day of week, history data, etc.).

After receiving the authorization request transmitted by key 102, controller 104 waits to receive an authorization response from server 106 or for another authorization request from key 102.

After receiving the authorization request transmitted by key 102, server 106 determines whether or not to perform the enhanced authorization process. In any event, server 106 will send to either key 102 or controller 104 an authorization response, which response will either indicate an ACK (key is authorized to proceed) or indicate a NACK (key is not authorized to proceed).

Assuming controller receives the response from server 106 and the response is indicating an ACK, controller will then decide based on the authorization data included in the authorization request controller received from key and/or data included in the response from server 106 whether to perform the action, not perform the action, or yet again escalate to the server, indicating that further authorization is needed. (as described below with respect to FIG. 6).

Assuming key receives the response from server 106 and the response is indicating an ACK, key will then send to controller 104 an authorization request that includes data that was included in the response from server 106. Upon receiving this second authorization request from key, controller decides based on the authorization data included in the second authorization request whether to perform the action, not perform the action, or escalate to the server (as described below with respect to FIG. 6).

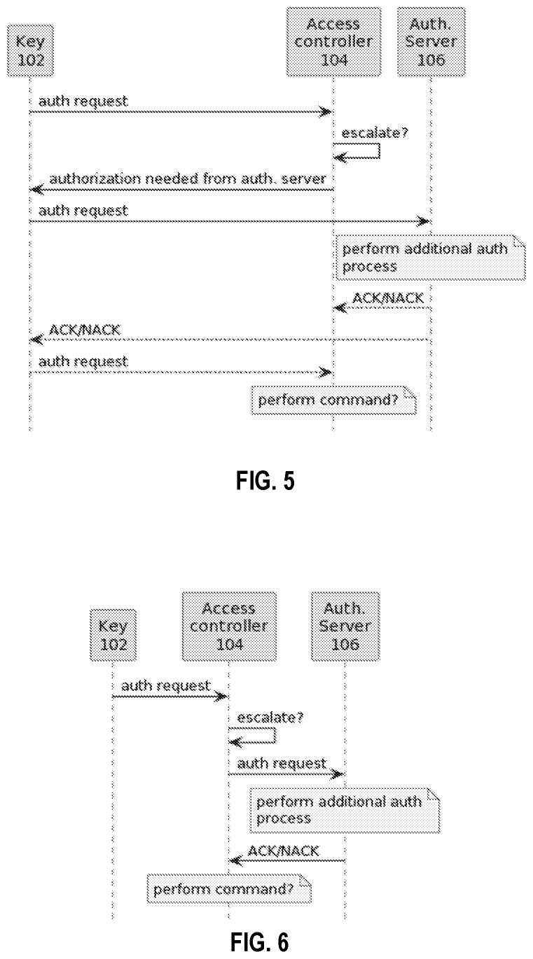

FIG. 5 is a message flow diagram illustrating a message flow according to an embodiment where key 102 sends to controller 104 (e.g., using short range radio) a first authorization request including authorization data.

In response to receiving the authorization request, controller determines based on information in the authorization request and/or context whether authorization escalation is needed. If escalation is needed, controller transmits to key a response message responsive to the authorization request where the response message indicates to key authorization is needed from server 106.

In response to receiving this response message from controller 104, key 102 sends an authorization request to server 106.

After receiving the authorization request transmitted by key 102, server 106 determines whether or not to perform the enhanced authorization process. In any event, server 106 will send to either key 102 or controller 104 an authorization response, which response will either indicate an ACK (key is authorized to proceed) or indicate a NACK (key is not authorized to proceed).

Assuming controller receives the response from server 106 and the response is indicating an ACK, controller will then decide based on the authorization data included in the authorization request controller received from key and/or data included in the response from server 106 whether to perform the action, not perform the action, or escalate to the server (as described below with respect to FIG. 6).

Assuming key receives the response from server 106 and the response is indicating an ACK, key will then send to controller 104 an authorization request that includes data that was included in the response from server 106. Upon receiving this second authorization request from key, controller decides based on the authorization data included in the second authorization request whether to perform the action, not perform the action, or escalate to the server (as described below with respect to FIG. 6).

### Authorization Request Message From Access Controller

FIG. 6 is a message flow diagram illustrating a message flow according to an embodiment where key 102 sends to controller 104 (e.g., using short range radio) a first authorization request including authorization data.

In response to receiving the authorization request, in one embodiment, controller automatically sends an authorization request to server 106. In another embodiment, controller evaluates, based on information in the authorization request and/or context, whether authorization escalation is needed. If escalation is needed, controller transmits an authorization request to server 106. The evaluation in the access controller 104 may include determining whether st>threshold, where st is the signal strength of the signal received from key 102. The evaluation may instead or further include determining the time of day, determining day of the week, determining the location of the key, and/or evaluating history data.

After receiving the authorization request transmitted by controller 104, server 106 determines whether or not to perform the enhanced authorization process. In any event, server 106 will send to controller 104 an authorization response, which response will either indicate an ACK (key is authorized to proceed) or indicate a NACK (key is not authorized to proceed).

Assuming controller receives the response from server 106 and the response is indicating an ACK, controller will then decide based on the authorization data included in the authorization request controller received from key and/or data included in the response from server 106 whether to perform the action, not perform the action, or yet again escalate to the server to indicate that further authorization is needed.

### Enhanced Authorization Process

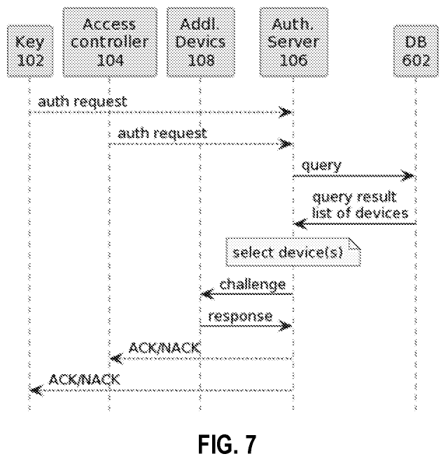

FIG. 7 is a message flow diagram illustrating steps of the enhanced authorization process according to some embodiments. As shown in FIG. 7, server 106 receives an authorization request, where the authorization request was transmitted either by key 102 or controller 104. As noted above, the authorization request includes authorization data that may include various ids (e.g., key id for identifying key 102, a user id for identifying the user of key 102), context information, truest level information indicating the trustworthiness of key and/or access controller, signal strength information, etc.

Server evaluates the authorization data and possibly other data (e.g., historical usage pattern information) to assess whether to proceed with enhanced authorization. If server decides to proceed with enhanced authorization, then, in the example embodiment shown, server sends a query to a database (DB) 702. In one embodiment, the query includes the key id and/or user id (uid). DB 702, in response to query, uses data from query to search for information. For example, if query includes a uid, then DB uses the uid to retrieve info associated in the database with the uid, like a user profile. DB 702 then sends to server a query response responsive to the query. In this example, a uid in the query was used to retrieve a user profile associated with the uid, where the profile includes a list of devices that the user of key 102 had registered (e.g., the user's smart phone, smart watch, smart glasses, etc.), and the query response includes the list of devices (i.e., the set of additional devices 108). The response may further include, for each additional device, contact information for the device (e.g., IP address, phone number, domain name), capability information, and trust level information indicating a trust level of the additional device.

Server will then select which additional devices from the list of additional devices will be used for further verification/authorization. The selection may be: one or more of the available devices; one or more of the available devices having a trust level about a threshold; one or more of the available devices having a certain capability (GUI, audio, haptics, inertial measurement unit (IMU), etc.); a randomly selected subset of the available devices; or a combination of the above.

For each selected additional device, server sends a message to the device (e.g., a challenge message) and the device responds to the message by sending a response message (e.g., a response to the challenge). Depending on the content of the responses server receives from the selected device(s), server decides whether or not to authorize the user's action, and, as illustrated, server 106 will send to either key 102 or controller 104 an authorization response, which response will either indicate an ACK (key is authorized to proceed) or indicate a NACK (key is not authorized to proceed).

### Multi-device Authentication

There exist several technical solutions to implement the proposed escalation. One common variant is that each selected additional device has its own private key, which can be used to sign a challenge sent by the server. Signing the challenge acts as an authentication towards the server as well as an implicit authorization approval. Alternatively, after authentication (by e.g. signing the challenge) the server and the device might exchange information about the authorization request (what entity is requesting to access what entity, etc.) and the device can decide how it wants to respond (accept/reject).

Other alternatives of challenge-response mechanism include parametrized one-way function OWF (e.g., keyed MAC) and secret sharing schemes. The server will need to have knowledge of the expected response, e.g., by knowing the MAC key or model of the respective additional device.

In the simplest scenario, the server supplies a challenge to the selected devices and awaits a response. The response may be dependent on user interaction with said devices.

In one embodiment, the server selects which devices to user for the enhanced authorization based on the device's proximity to key (e.g., carried by the same user carrying key 102). The additional devices will need to verify that they detect key 102 using short-range communication, or if capable, report their geographical location so that the server can verify they are in close enough proximity.

In case presence of key 102 needs to be verified, the challenge may be split, and the server instructs key 102 to send one part of the challenge using short-range communication to the additional device (e.g. Bluetooth, NFC, RFID) while supplying the other half using long-range communication such as WiFi, LTE or 5G. This may be referred to as “split challenge” or “multi-path challenge”. Only devices in proximity of key 102 will be able to correctly answer; i.e. collect both parts of the challenge and compute a response to the combined challenge. The response is then communicated to the server for verification.

It is also possible for the server and/or key 102 to use different types short-range/long-range communication methods in the split challenge scenario. E.g., the server supplies challenge L₁ using WiFi and L₂ using 3GPP while key 102 supplies challenge S₁ using Bluetooth and challenge S₂ using NFC. A device capable of WiFi and NFC receives challenge L₁S₂ while a device capable of 3GPP connectivity and Bluetooth receives L₂S₁, etc. This may be beneficial in a situation where the additional devices are heterogeneous in their capabilities and/or where the bar for a malicious device trying to emulate being one of the legitimate devices should be made even more difficult.

The split challenge-embodiment can further be combined with additional devices passing along the challenge after producing a response. For example, key 102 and/or the server send a challenge to a particular device (D1) along with an instruction of which devices to send it to the next (e.g., device D2). After computing its response, device D1 sends it to D2 and adds its response, etc. When the last device has responded, the entire chain of responses is returned to either key 102 or the server, depending on embodiment.

In another embodiment, which may or may not utilize the split challenge mechanisms described above, the set of additional devices may have been given a share in a secret sharing scheme. Secret sharing schemes, such as Shamir's scheme, are built on a secret being recoverable if t out of n participants supply a valid share. Shamir's scheme is built on the principle that x+1 points on a two-dimensional exponential curve defined by a polynomial of degree x will define the exact polynomial, while <x+1 points will not. The goal of the secret sharing scheme is to recover a “master secret” which in Shamir's case is defined as a specific point on the curve, e.g. (0,y). To exemplify, a fifth-degree polynomial requires 6 points/shares on the curve for an exact definition. If ten devices are given one share each, we have created a 6-of-10 secret sharing scheme. The general definition of such a sharing scheme is t-of-n sharing scheme. Other similar approach may include threshold encryption where a key may be split in n shared where t(<=n) may be required for use thereof.

In an embodiment utilizing secret sharing, key 102 may contain one share and the scheme require t-1 additional devices to correctly respond to unlock the “master secret”. The server selects at least t-1 additional devices which should send their share. The calculation of the master secret can either be done by the server directly (i.e., all selected devices provide their share to the server) or by key 102. In the latter, key 102 proves that it has been in contact with all t-1 devices by being able to present the master secret to the server. Only if the correct secret can be calculated by the server or key 102, the authentication is accepted. The server may suggest more than t-1 devices to make the authentication robust against devices currently not present.

The shares may be one-time use and replaced after each escalation attempt. The additional devices may hold further several shares belonging to different master secrets. In this case, the server may instruct key 102 and the additional devices, which shares to use. Alternatively, or additionally, the shares may be supplied encrypted and handled within a secure enclave upon receival, thereby never exposing the share outside the secure enclave.

Continuing on the secret sharing embodiment, in some cases, two devices within the set of additional devices may need to be simultaneously present to be valid to respond to an escalation request. E.g., a smart shoe may need its partner to be deemed reliable. In these cases, a layer secret sharing scheme can be utilized, i.e., device A and B have one partial share each (e.g., an X coordinate and the corresponding Y-coordinate respectively) and may only contribute if both are present.

### Rental Car Use Case

The employee at a car rental agency might have at least one device associated to the rental service. A rental car and its key are also registered to the car rental service.

A customer carrying multiple devices (e.g., smartphone, smartwatch and AR glasses) registers each device (i.e., the user or the device's themselves provide information to the rental agency) and the registered devices are associated with the rented car and the car key. Additionally, all or some of the registered devices may be considered trusted by the rental agency (these trusted devices from the “trusted set of devices”). For example, the rental customer puts some of the customer's wearables into the trusted set being associated with the car rental activity; you may have that rental of a compact car may require association of one wearable device, whereas rental of an expensive luxury car or sports car may require some increased level of association from the potential renter.

The above mentioned device registration step may include, for each device:
(1) Requesting user device interaction (pairing) direct to device, or to a device managing server that holds information about the device (register user device to renting context at rental server by direct interaction with user's device e.g. through pairing, or by interacting with device's managing server);
(2) obtaining device identity, device authentication capabilities mechanism, from device or device's managing server (collect device information, from device or from device managing server, such as identity, authentication capabilities etc.);
(3) obtaining from the device or the device's managing server, list of attribute and capabilities and a related authentication strength score; and/or
(4) based on rental sessions context and attributes, determining if individual capabilities and a related authentication strength score are sufficient in relation to rental objective, as of per individual device, or per aggregation over cluster of devices; if sufficient, then the device may be added to the trusted set of devices.

When satisfactory renter-authentication is determined (e.g. sufficiently many devices are in the trusted set such that the user has a total trust score greater than a threshold, the rental server operated by the rental company may:
(1) associate the trusted devices with the rental car;
(2) associate set of access rules (lock, unlock, etc.) to rental car;
(3) associate set of thresholds and associated duration for associated rental car to be present/active/online/etc., to manage e.g. power status challenges;
(4) establish revocation rules (e.g., how rental object and renter server should react when a previously defined set of renter devices no longer are determined present (complying to agreed renter-rental authentication principles).

In this use case, the server 106 may be operated by or for the rental agency. And, as described above, server 106 may perform enhanced authorization. For example, server 106 may receive an authorization request triggered from the car key, the car, or one of the trusted devices.

Depending on data in the authorization request and context, usage patterns, object value, etc. server 106 may depending on in previous steps determined authentication/challenge capability, further require additional renter authentications according to:
(a) including additional customer devices (wearable, smartphone, smartwatch, AR glasses),
(b) including additional customer devices (according to above) carrying specifically required authentication capability (e.g., for this rental car, rental agency requires capability X, where X may include certain biometric sensor readout, etc.) and/or including co-driver devices,
(c) require someone from the rental car agency to do an additional authentication procedure, e.g. associated with physical person, and/or
(d) indicate, based on response from the server to the authorization request, that the trusted devices do not provide sufficient authentication fulfilment, and then rental agency may suggest renter to add a specific device that based on information from server 106 is estimated to add required additional authentication strength/capability.

### Further Aspects—Device Status

In some embodiment, when the renter attempts to register a device to the rental agency for the enhanced authorization, the device's status attributes, such as e.g. battery status. may be subject to consideration. For instance, a device with battery life<threshold may not be allowed into set of trusted devices. As another example, a device with expected uptime<threshold may not be added to the set of trusted devices.

### Further Aspects—User-initiated Interchange of Authenticating Devices

It may occur that a device subject to agreed authentication scheme is determined malfunctioning during ongoing rental session, e.g. approaching power shortage, and has to be interchange with some other functional device. This would require a switch process where the device to be switched out does not need to be involved (e.g. if it cannot participate due to malfunction). In this case, renting user may trigger a “device-swap” message to the rental company server. The “device-swap” message may include: device id of the device to be replaced (i.e., swapped out), device id of the selected device that was to replace the device being swapped out, capability information for the selected device

The rental company server receives device swap request and determines if the selected device to replace the device to be swapped out is sufficient (e.g., trust score is greater than threshold). If the selected device is sufficient, then the device to be swapped out is removed from the trusted set of devices and the selected device is added to the set of trusted devices.

### Further Aspects Car Rental Continuous Driver Authentication

A further aspect to consider is the fact that some car rental companies charge extra for allowing multiple drivers. Accordingly, in some embodiments, the rental agency would like to keep track of who is actually driving the car.

Accordingly, in one embodiment, the rental company installs sensors in the car which can communicate with the driver's associated smart devices. One example could be that the driver's seat, steering wheel, or similar, has/have capabilities to communicate with the driver's associated smart devices or wearables to verify the driver on a regular basis. Additionally, the car may have face recognition capabilities for identifying the driver of the car.

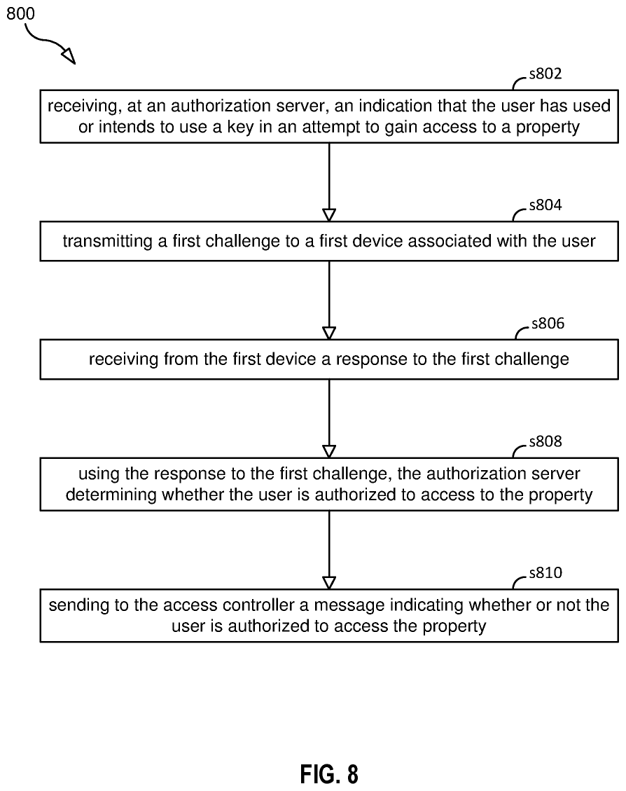

FIG. 8 is a flow chart illustrating a process 800, according to an embodiment. Process 800 is performed by server 106. Process 800 may begin in step s802.

Step s802 comprises server 106 receiving an indication that the user has used or intends to use a key in an attempt to gain access to a property (e.g., a physical property (e.g., car, building, room) or non-physical (service, digital object)), wherein access to the property is controlled by an access controller. For example, step s802 comprises server 106 receiving the auth request message transmitted to server in any of FIGS. 3-7.

Step s804 comprises, after receiving the indication, server 106 transmitting a first challenge to a first device associated with the user (the first device may be separate and apart from the key).

Step s806 comprises server 106 receiving from the first device a response to the first challenge.

Step s808 comprises server 106, using the response to the first challenge determining whether the user is authorized to access to the property.

Step s810 comprises server 106 sending a message indicating whether or not the user is authorized to access the property.

In some embodiments, the key is a key fob, the key is a reconfigurable logic component (e.g., an FPGA) within another device, the key is a hardware component (e.g., integrated circuit card (ICC)) within another device (e.g., a phone), and/or the key is a software component.

In some embodiments, the server receives the indication from the access controller; in other embodiments, the server receives the indication from the key.

In some embodiment process 800 also includes, after receiving the indication and prior to transmitting the first challenge to the first device associated with the user: obtaining context information; and determining, based on the context information, that an additional level of security is required, wherein the authorization server transmits the first challenge as a result of determining that the additional level of security is required. In some embodiments, receiving the indication comprises receiving a message indicating that the user has used a key in an attempt to gain access to a property, and the message comprises the context information (e.g., location information).

In some embodiment process 800 also includes, prior to transmitting the first challenge to the first device associated with the user, determining that the first device is accessible.

In some embodiment process 800 also includes: prior to transmitting the first challenge to the first device associated with the user, accessing a database to obtain a list of devices associated with the user, wherein the first device to which the first challenge is sent is selected from the list of devices.

In some embodiments, transmitting the first challenge to the first device comprises: transmitting the first challenge using a short range radio transmitter (e.g., Bluetooth); transmitting the first challenge to a second device configured to forward the first challenge to the first device; or transmitting a first part of the first challenge to the first device and transmitting a second part of the first challenge to a second device configured to forward the second part of the first challenge to the first device.

In some embodiment process 800 also includes: after receiving the indication, the authorization server transmitting a second challenge to a second device associated with the user (e.g., the first and second challenges may be transmitted simultaneously); the authorization server receiving from the second device a response to the second challenge; and using the response to the first challenge and/or the response to the second challenge, the authorization server determining whether the user is authorized to access to the property.

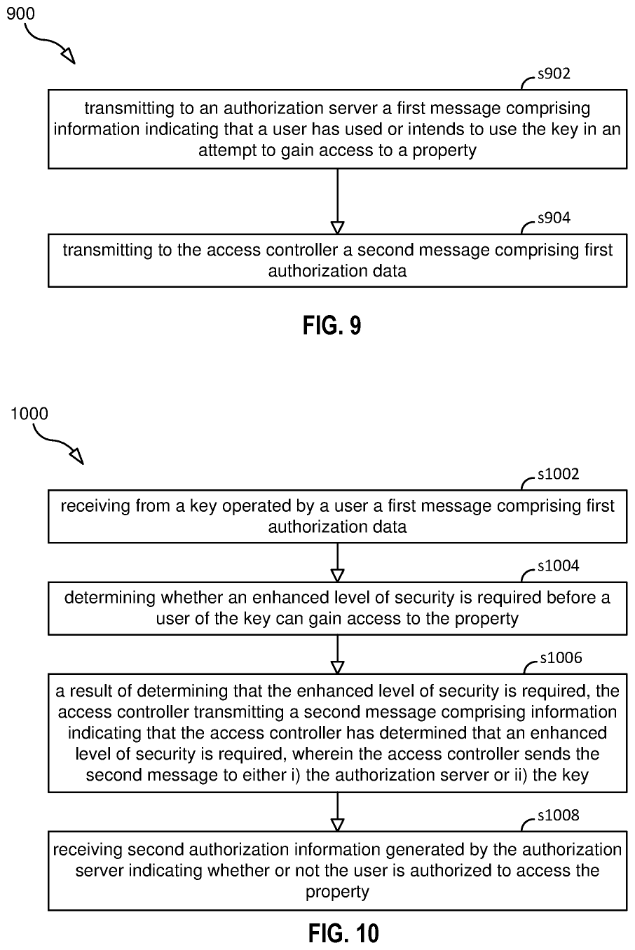

FIG. 9 is a flow chart illustrating a process 900, according to an embodiment. Process 900 is performed by key 102. Process 900 may begin in step s902.

Step s902 comprises the key transmitting to an authorization server a first message comprising information indicating that a user has used or intends to use the key in an attempt to gain access to a property, wherein access to the property is controlled by an access controller.

Step s904 comprises the key transmitting to the access controller a second message comprising first authorization data (e.g., information that enables the access controller to determine that key is authorized).

In some embodiments, the key transmits the second message prior to transmitting the first message, the method further comprises the key receiving from the access controller a response message responsive to the second message, the response message indicating that further authorization is required, and the key transmits the first message to the authorization server in response to receiving the response message from the access controller.

In some embodiments, the key transmits the first message prior to transmitting the second message.

In some embodiment process 900 also includes the key receiving from the authorization server a response message responsive to the first message, the response message responsive to the first message comprising second authorization data, wherein the second message transmitted by the key to the access controller further comprises the second authorization data.

FIG. 10 is a flow chart illustrating a process 1000, according to an embodiment. Process 1000 is performed by access controller 104, which is configured to control access to a property. Process 1000 may begin in step s1002.

Step s1002 comprises the access controller receiving from a key operated by a user a first message comprising first authorization data.

Step s1004 comprises, after receiving the first message, the access controller determining whether an enhanced level of security is required before a user of the key can gain access to the property.

Step s1006 comprises, as a result of determining that the enhanced level of security is required, the access controller transmitting a second message comprising information indicating that the access controller has determined that an enhanced level of security is required, wherein the access controller sends the second message to either i) the authorization server or ii) the key.

Step s1008 comprises, after transmitting the second message, receiving second authorization data generated by the authorization server indicating whether or not the user is authorized to access the property.

In some embodiments process 1000 also includes, after transmitting the second message, receiving a third message transmitted by the key, wherein the third message comprises the second authorization data.

In some embodiments process 1000 also includes, after transmitting the second message, receiving a third message transmitted by the authorization server, wherein the third message comprises the second authorization data.

In some embodiments determining whether the enhanced level of security is required comprises: the access controller obtaining context information and the access controller using the context information to determine whether the enhanced level of security is required. In some embodiments the context information comprises: location information indicating a current location of the key, time information indicating a current time of day, and/or key information comprising information about the key.

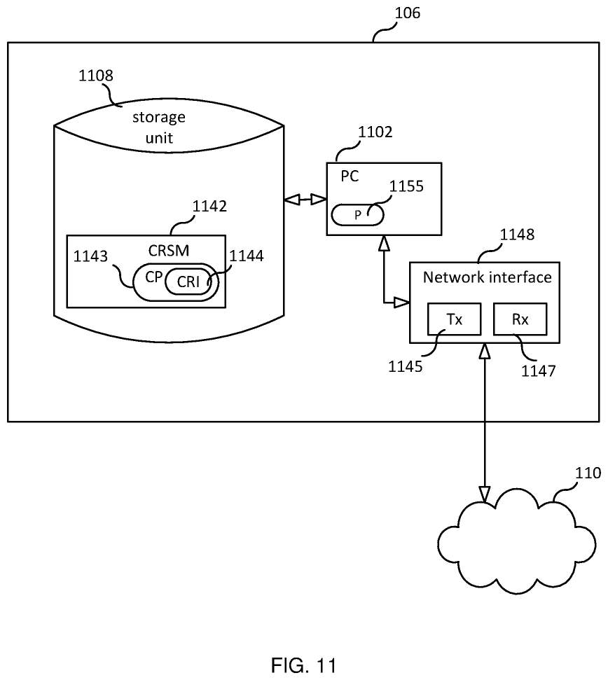

FIG. 11 is a block diagram of server 106, according to some embodiments. As shown in FIG. 11, server 106 may comprise: processing circuitry (PC) 1102, which may include one or more processors (P) 1155 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., server 106 may be a distributed computing apparatus); at least one network interface 1148 (e.g., a physical interface or air interface) comprising a transmitter (Tx) 1145 and a receiver (Rx) 1147 for enabling server 106 to transmit data to and receive data from other nodes connected to a network 110 (e.g., an Internet Protocol (IP) network) to which network interface 1148 is connected (physically or wirelessly) (e.g., network interface 1148 may be coupled to an antenna arrangement comprising one or more antennas for enabling server 106 to wirelessly transmit/receive data); and a storage unit (a.k.a., “data storage system”) 1108, which may include one or more non-volatile storage devices and/or one or more volatile storage devices. In embodiments where PC 1102 includes a programmable processor, a computer readable storage medium (CRSM) 1142 may be provided. CRSM 1142 may store a computer program (CP) 1143 comprising computer readable instructions (CRI) 1144. CRSM 1142 may be a non-transitory computer readable medium, such as, magnetic media (e.g., a hard disk), optical media, memory devices (e.g., random access memory, flash memory), and the like. In some embodiments, the CRI 1144 of computer program 1143 is configured such that when executed by PC 1102, the CRI causes server 106 to perform steps described herein (e.g., steps described herein with reference to the flow charts). In other embodiments, server 106 may be configured to perform steps described herein without the need for code. That is, for example, PC 1102 may consist merely of one or more ASICs. Hence, the features of the embodiments described herein may be implemented in hardware and/or software.

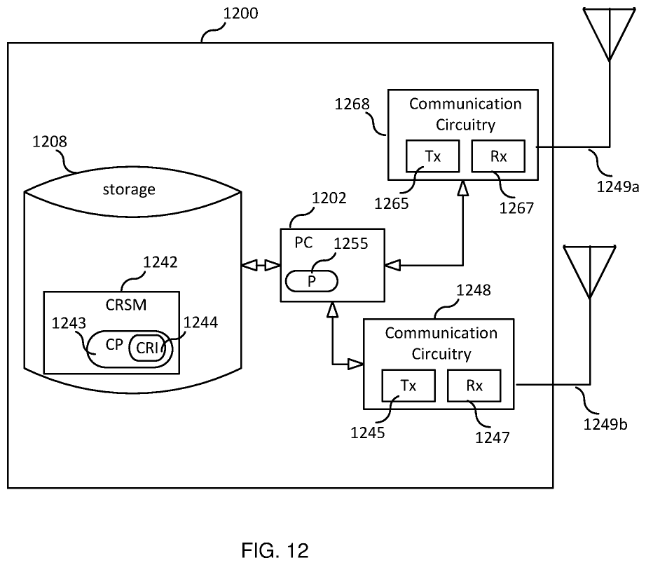

FIG. 12 is a block diagram of a device 1200, according to some embodiments for performing the key or access controller methods disclosed herein. That is key 102 and/or access controller 103 may have the configuration shown in FIG. 12. As shown in FIG. 12, device 1200 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., device 1200 may be a distributed computing apparatus); communication circuitry 1268 (e.g., radio transceiver circuitry comprising a transmitter (Tx) 1265 and a receiver (Rx) 1267) coupled to an antenna system 1249a for short range wireless communication (e.g., Bluetooth); additional communication circuitry 1248 (e.g., radio transceiver circuitry comprising an Rx 1247 and a Tx 1245) coupled to an antenna system 1249b for long range (e.g., cellular) wireless communication; and a storage unit (a.k. a., “data storage system”) 1208, which may include one or more non-volatile storage devices and/or one or more volatile storage devices. In embodiments where PC 1202 includes a programmable processor, a computer readable storage medium (CRSM) 1242 may be provided. CRSM 1242 may store a computer program (CP) 1243 comprising computer readable instructions (CRI) 1244. CRSM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes device 1200 to perform steps described herein (e.g., steps described herein with reference to one or more flow charts). In other embodiments, device 1200 may be configured to perform steps described herein without the need for code. That is, for example, PC 1202 may consist merely of one or more ASICs. Hence, the features of the embodiments described herein may be implemented in hardware and/or software.

### Conclusion

Embodiments disclosed herein provide an additional level of security when needed by, for example, having an authorization server involve devices to perform multi-step validation of an action, depending on surrounding factors and any consequent risks involved.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for access control, the method comprising:
receiving, at an authorization server, an indication that the user has used or intends to use a key in an attempt to gain access to a property wherein access to the property is controlled by an access controller;
after receiving the indication, the authorization server transmitting a first challenge to a first device associated with the user;
the authorization server receiving from the first device a response to the first challenge;
using the response to the first challenge, the authorization server determining whether the user is authorized to access to the property; and
the authorization server sending a message indicating whether or not the user is authorized to access the property.

2. The method of claim 1, wherein
the key is a key fob,
the key is a reconfigurable logic component within another device,
the key is a hardware component within another device, and/or
the key is a software component.

3. The method of claim 1, wherein
the authorization server receives the indication from the access controller, or
the authorization server receives the indication from the key.

4. (canceled)

5. The method of claim 1, further comprising, after receiving the indication and prior to transmitting the first challenge to the first device associated with the user:
obtaining context information; and
determining, based on the context information, that an additional level of security is required, wherein
the authorization server transmits the first challenge as a result of determining that the additional level of security is required.

6. The method of claim 5, wherein
receiving the indication comprises receiving a message indicating that the user has used a key in an attempt to gain access to a property, and
the message comprises the context information.

7. The method of claim 1, further comprising, prior to transmitting the first challenge to the first device associated with the user, determining that the first device is accessible.

8. The method of claim 1, further comprising:
prior to transmitting the first challenge to the first device associated with the user, accessing a database to obtain a list of devices associated with the user, wherein
the first device to which the first challenge is sent is selected from the list of devices.

9. The method of claim 1, wherein transmitting the first challenge to the first device comprises:
transmitting the first challenge using a short range radio transmitter;
transmitting the first challenge to a second device configured to forward the first challenge to the first device; or
transmitting a first part of the first challenge to the first device and transmitting a second part of the first challenge to a second device configured to forward the second part of the first challenge to the first device.

10. The method of claim 1, further comprising:
after receiving the indication, the authorization server transmitting a second challenge to a second device associated with the user;
the authorization server receiving from the second device a response to the second challenge; and
using the response to the first challenge and/or the response to the second challenge, the authorization server determining whether the user is authorized to access to the property.

11. A method for access control performed by a key, the method comprising:
the key transmitting to an authorization server a first message comprising information indicating that a user has used or intends to use the key in an attempt to gain access to a property, wherein access to the property is controlled by an access controller; and
the key transmitting to the access controller a second message comprising first authorization data.

12. The method of claim 11, wherein
the key transmits the second message prior to transmitting the first message,
the method further comprises the key receiving from the access controller a response message responsive to the second message, the response message indicating that further authentication is required, and
the key transmits the first message to the authorization server in response to receiving the response message from the access controller.

13. The method of claim 11, wherein the key transmits the first message prior to transmitting the second message.

14. The method of claim 11, further comprising:
the key receiving from the authorization server a response message responsive to the first message, the response message responsive to the first message comprising second authorization data, wherein
the second message transmitted by the key to the access controller further comprises the second authorization data.

15. A method for access control performed by an access controller configured to control access to a property, the method comprising:
the access controller receiving from a key operated by a user a first message comprising first authorization data;
after receiving the first message, the access controller determining whether an enhanced level of security is required before a user of the key can gain access to the property;
as a result of determining that the enhanced level of security is required, the access controller transmitting a second message comprising information indicating that the access controller has determined that an enhanced level of security is required, wherein the access controller sends the second message to either i) an authorization server or ii) the key; and
after transmitting the second message, receiving second authorization data generated by the authorization server indicating whether or not the user is authorized to access the property.

16. The method of claim 15, further comprising,
after transmitting the second message, receiving a third message transmitted by the key, wherein the third message comprises the second authorization data, or
after transmitting the second message, receiving a third message transmitted by the authorization server, wherein the third message comprises the second authorization data.

17. (canceled)

18. The method of claim 15, wherein determining whether the enhanced level of security is required comprises:
the access controller obtaining context information; and
the access controller using the context information to determine whether the enhanced level of security is required.

19. (canceled)

20. The method of claim 18, wherein the context information comprises location information indicating a current location of the key.

21. An authorization server configured to perform a method comprising:
receiving an indication that the user has used or intends to use a key in an attempt to gain access to a property, wherein access to the property is controlled by an access controller;
after receiving the indication, transmitting a first challenge to a first device associated with the user;
receiving from the first device a response to the first challenge;
using the response to the first challenge, determining whether the user is authorized to access to the property; and
sending a message indicating whether or not the user is authorized to access the property.

22-30. (canceled)

31. A key, the key comprising:
a transmitter; and
processing circuitry, wherein the key is configured to perform the method of claim 11.

32-34. (canceled)

35. An access controller for controlling access to a property, the access controller comprising:
a receiver; and
processing circuitry, wherein the access controller is configured to perform the method of claim 15.

36-42. (canceled)
